(19) United States
(12) Patent Application Publication
(10) Pub. No.: US 2006/0229933 A1
(43) Pub. Date: Oct. 12, 2006

(54) Systems and methods for exclusively capturing quality of service

(76) Inventor: Joseph A. Stith, South Jordan, UT (US)

Correspondence Address: KIRTON & McCONKIE;Suite 1800, 60 East South Temple, Salt Lake City, UT, 84111, US

(21) Appl. No.: 11/403,147

(22) Filed: Apr. 11, 2006

Related U.S. Application Data
(60) Provisional application No. 60/670,191, filed on Apr. 11, 2005.

(51) Int. Cl. G07G 1/00; G06Q 99/00

(52) U.S. Cl. 705/10; 705/1

(57) ABSTRACT

Systems and methods for developing exclusive rights to providing informational feedback relating to a quality of service received from a professional, delivering an authorized request for feedback submission, receiving informational feedback, and selectively compiling the informational feedback received for reporting purposes. A computer system is configured to receive exclusive informational feedback relating to a quality of service received. Receivers of service from a professional are exclusively invited to submit informational feedback relating to the quality of service they received. Upon receipt of the information, the response is incorporated with other informational feedback responses received and preserved in the system. The system allows for the compilation of selectively customizable reports that may be generated for potential customers and/or to inform the professional relating to its quality of service rendered.

### RELATED APPLICATIONS

This application claims priority to U.S. Provisional Patent Application Ser. No. 60/670,191 filed Apr. 11, 2005, entitled SYSTEMS AND METHODS FOR EXCLUSIVELY CAPTURING QUALITY OF SERVICE.

### BACKGROUND OF THE INVENTION

1. Field of the Invention

The present invention relates to systems and methods for capturing quality of service. In particular, the present invention relates systems and methods for developing exclusive rights to providing informational feedback relating to a quality of service received from a professional, delivering an authorized request for feedback submission, receiving informational feedback, and selectively compiling the informational feedback received for reporting purposes.

2. Background and Related Art

Currently, customers are able to purchase or otherwise obtain a variety of professional services that are available through one or more of a variety of different service providers. In determining which service provider to select, it has proved difficult for customers to know in advance the quality of service that is rendered by a particular service provider.

Thus, while a variety of services providers are available to customers for the purchasing or otherwise obtaining needed professional services, challenges exist that enable customers to know in advance the quality of service that can be obtained from any of the particular service providers. Accordingly, it would be an improvement in the art to augment or even replace current techniques with other techniques.

### SUMMARY OF THE INVENTION

The present invention relates to systems and methods for capturing quality of service. In particular, the present invention relates systems and methods for developing exclusive rights to providing informational feedback relating to a quality of service received from a professional, delivering an authorized request for feedback submission, receiving informational feedback, and selectively compiling the informational feedback received for reporting purposes.

Implementation of the present invention takes place in association with a computer system that is configured to receive exclusive informational feedback relating to a quality of service received. In one implementation, receivers of service, such as customers and clients, receive service from professionals. The receivers of the service identified are exclusively invited to submit informational feedback relating to the quality of service they received. For example, the invitations for submissions are provided by the professionals rendering the service and/or the system. The exclusive nature is extended directly to receivers of the service rather than the public at large or competitors of the professional. A code is provided to the receivers of the service, wherein the code provides for a single response of informational feedback relating to the service received. If a response corresponding to the code has not been received, the system automatically contacts the receiver of the service upon the passage of a predetermined period of time to request submission of the informational feedback response. Upon receipt of the response, the response is incorporated with other informational feedback responses received and preserved in the system.

The system allows for the compilation of selectively customizable reports that may be generated for potential customers and/or to inform the professional relating to its quality of service rendered. Such reports may include facts relating to the professional and/or a rating or quality of service rendered by the particular professional

In one implementation, receivers of service electronically submit informational feedback responses to a clearinghouse via a network computer system. In a further implementation, the network is the internet, allowing users to use the code received to log on a given webpage and electronically submit informational feedback responses. In other implementations, data is gathered from the receivers of service via telephone, email or hard copy surveys. The information may then be incorporated into a particular system. In some implementations, the responses are surveys that are answered by the receivers of the service rendered.

While the methods and processes of the present invention have proven to be particularly useful in the funeral service industry, those skilled in the art can appreciate that the methods and processes of the present invention are used in a variety of different industries to promote an increased quality of service rendered by professionals by exclusively involving receivers of the service. Examples of other industries include sales, construction, personal services, the automotive industry, the healthcare industry, the dental industry, the legal industry, the consulting industry, the cemetery industry, the cremation industry, and any other industry that provides a service.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates an example of a networked environment of the representative system of FIG. 1; and

FIG. 3 illustrates a flow chart that provides a representative embodiment of exclusively capturing quality of service.

### DETAILED DESCRIPTION OF THE INVENTION

The present invention relates to systems and methods for capturing quality of service. In particular, the present invention relates systems and methods for developing exclusive rights to providing informational feedback relating to a quality of service received from a professional, delivering an authorized request for feedback submission, receiving informational feedback, and selectively compiling the informational feedback received for reporting purposes.

Embodiments of the present invention take place in association with a system that is configured to receive exclusive informational feedback relating to a quality of service received. In one embodiment, receivers of service, such as customers and clients, receive service from professionals. The receivers of the service identified are exclusively invited to submit informational feedback relating to the quality of service received. The invitations for submissions are provided by the professionals rendering the service and/or by the system. The exclusive nature is extended to receivers of the service rather than the public at large or competitors of the professional.

In some embodiments, a code is provided to the receivers of the service, wherein the code provides for a single response of informational feedback relating to the service received. If a response corresponding to the code has not been received, the system automatically contacts the receiver of the service upon passage of a predetermined period of time to request submission of the informational feedback response. Upon receipt of the response, the response is incorporated with other informational feedback responses received and preserved in the system. The system allows for compilation of selectively customizable reports that may be generated for potential customers and/or to inform the professional relating to its quality of service rendered.

In some embodiments, receivers of service electronically submit informational feedback responses to a clearinghouse via a network computer system. In a further embodiment, the network is the internet, allowing users to use the code received to log on a given webpage and electronically submit informational feedback responses. In some embodiments, the responses are surveys that are answered by the receivers of the service rendered. In some embodiments, the submissions are made via telephone and/or may be entered by a representative of the system or professional.

Embodiments of the present invention embrace a variety of industries to promote an increased quality of service rendered by professionals by exclusively involving receivers of the service. Such industries include funeral service, sales, construction, personal services, automotive, healthcare, dental, legal, financial, consulting, cemetery, cremation, and any other industry that provides a service.

The following disclosure of the present invention is grouped into two subheadings, namely “Exemplary Operating Environment” and “Capturing Quality of Service.” The utilization of the subheadings is for convenience of the reader only and is not to be construed as limiting in any sense.

### Exemplary Operating Environment

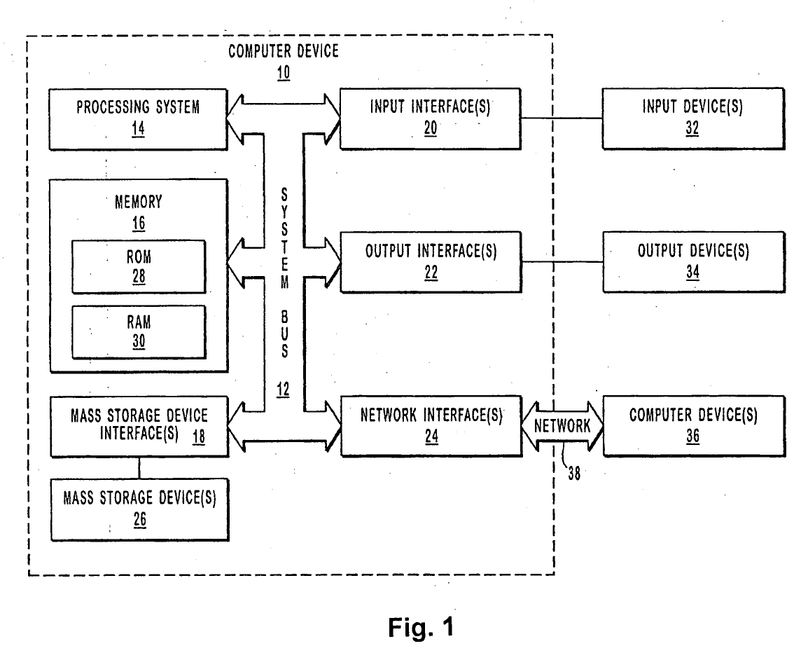

FIG. 1 and the corresponding discussion are intended to provide a general description of a computer device as a suitable operating environment for use in capturing a quality of service rendered. One skilled in the art will appreciate that the invention may be practiced by one or more computing devices and in a variety of system configurations, including in a networked configuration.

Embodiments of the present invention embrace one or more computer readable media that may be used to receive and/or record exclusive informational feedback relating to a service rendered by a professional or other service giver. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for providing, receiving and/or recording exclusive informational feedback includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and-allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network- interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

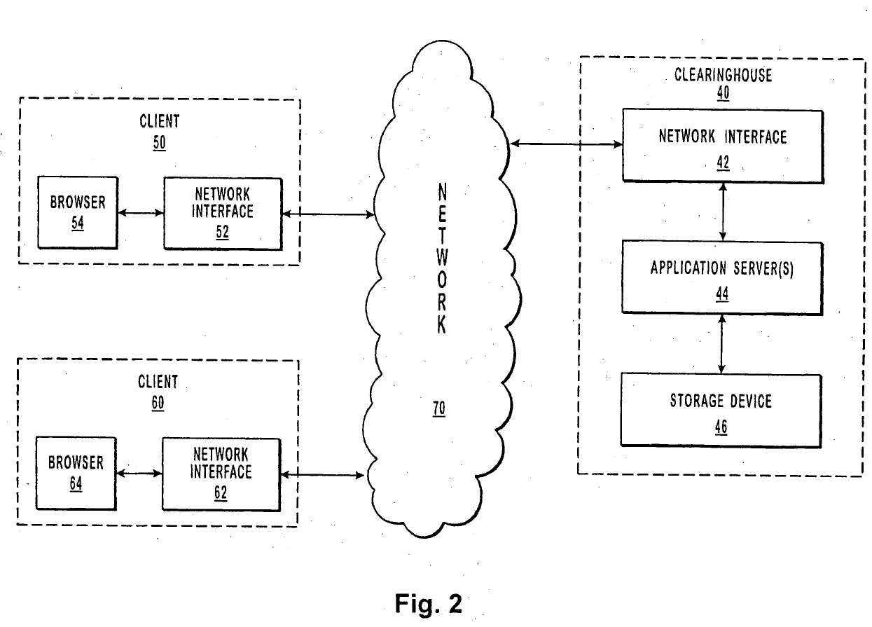

While those skilled in the art will appreciate that the invention may be practiced in networked computing environments with many types of computer system configurations, FIG. 2 represents an embodiment of the present invention that enables exclusive informational feedback relating to a quality of service rendered to be obtained from intended recipients and used for reporting purposes. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the internet.

In FIG. 2, clearinghouse 40 represents a system configuration that includes one or more servers that are used to receive and/or record exclusive informational feedback relating to services rendered, and customizably compiles the information for reporting purposes. By way of example, clearinghouse 40 may be a single server in cases where a single server can process and preserve the entire amount of information required to perform the methods and systems of the present invention, as will be further explained below. Alternatively, clearinghouse 40 may be a conglomeration of servers that process and preserve a high volume of information.

The emergence of the internet has enabled a very large number of computer devices across the world to be connected across a wide area network in order to participate in global communication. The following is a discussion of an embodiment of the present invention that includes a plurality of clients, illustrated as clients 50 and 60, which are connected to clearinghouse 40 across the internet, illustrated as network 70, in order to obtain and compile exclusive informational feedback relating to service rendered.

With reference to FIG. 2, clients 50 and 60 each include a network interface (respectively illustrated as network interfaces 52 and 62) and a Web Browser (respectively illustrated as browsers 54 and 64). Network interface 52 is a communication mechanism that allows a client, such as client 50 to communicate to clearinghouse 40 by a network 70, such as the internet. Browser 54 is an application program that allows information to be displayed on a monitor device as text and/or graphics in the form of a web page. A browser allows for the entering of uniform resource locator (“URL”) to thereby access the corresponding web page. Therefore, clients 50 and 60 may independently access a web page that enables the transmission of exclusive informational feedback relating to service rendered.

Clearinghouse 40 includes network interface 42, application servers 44, and storage device 46. Network interface 42 is a communication mechanism that allows clearinghouse 40 to communicate with one or more clients by a network 70. Application servers 44 include one or more servers for processing and/or preserving information, and may be employed for providing and maintaining a web page that enables receipt of exclusive informational feedback. Storage device 46 includes one or more storage devices for preserving exclusive informational feedback received. In one embodiment, storage device 46 further preserves information relating to exclusive codes passed to individuals as part of exclusively requesting informational feedback, as will be further explained below. Storage device 46 may be internal or external to application servers 44. Thus, a user at one of the clients, such as client 50, who has received a service and exclusively invited to submit informational feedback relating to the service may access a web page maintained by one or more of the application servers 44 and electronically submit the informational feedback. The informational feedback information is compiled by servers 44 and selectively utilized for customizable reports to service industries, service givers and/or to the public at large.

In one embodiment, clients 50 and 60 receive information from a receiver of service. For example the receiver of service provides the information via telephone, email, a hard copy survey, or another manner of communicating information. The information is received and input into the system at client 50.

In a further embodiment, client 50 is a kiosk to receive information from the receiver of the service regarding the quality of service received. In one embodiment, the kiosk is located in the office of the professional.

In a further embodiment, submission of the information relating to the service received provides value to the receiver of the service. Such value can include a discount off of the services received, a discount off of future services, value that can be used at another merchant or location, or another desired value.

While the discussion above has presented a representative system configuration for implementing the present- invention, those skilled in the art will appreciate that the methods of the present invention and processes thereof may be implemented in a variety of different system configurations.

### Capturing Quality of Service

As provided above, embodiments of the present invention embrace capturing quality of service rendered. In particular, the present invention relates systems and methods for developing exclusive rights to providing informational feedback relating to a quality of service received from a professional, delivering an authorized request for feedback submission, receiving informational feedback, and selectively compiling the informational feedback received for reporting purposes.

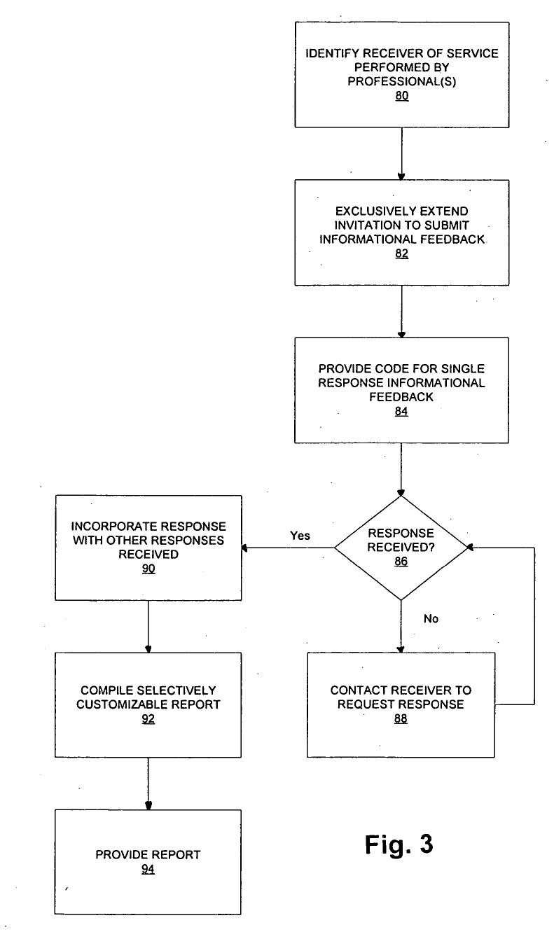

With reference to FIG. 3, a representative embodiment is illustrated for exclusively capturing quality of service. In FIG. 3, execution begins at step 80 where receivers of service performed by professionals or other service providers are identified. Execution then proceeds to step 82, wherein an exclusive invitation to submit informational feedback is extended to the identified receivers of service. In order to obtain information valuable to a service provider and in particular to service rendered, receivers of the service are separated from the public at large for exclusive participation in extending or submitting informational feedback for reporting purposes.

In one embodiment, a code is included as part of the exclusive invitation. The code allows for a single response to be submitted as informational feedback per receiver of service. Once the exclusive invitation is extended at step 82 and the code is provided at step 84, a determination is made at decision block 86 as to whether or not a particular response has been received. In a further embodiment, a system tracks whether or not a response has been received for each code given. If it is determined at decision block 86 that a particular response has not been received, the corresponding receiver is contacted at step 88. The examples of such contact include electronic contact, such as an e-mail message, or a non-electronic contact, such as a telephone call or via regular mail.

In one embodiment, an incentive is provided to the receiver of the service to provide information relating to the quality of service received. By way of example, such incentive may include a discount off of the services received, a discount off of future services, a certificate of value, or other incentives of value.

Once it is determined at decision block 86 that a response has been received, execution proceeds to step 90, wherein the response received is incorporated with other responses previously received by the system. At step 92, the information received is compiled to selectively and customizably report the information relating to quality of service. The report generated at step 92 is then provided at step 94.

In one embodiment, the service rendered relates to the funeral industry, wherein the customer receives from a funeral home service relating to care for a deceased loved one. The customer of the funeral home is identified and exclusively invited to submit information relating to the service provided by the funeral home. As part of the exclusive invitation, the customer receives a code or other tracking mechanism that allows the customer to log on to a website and provide information relating to the service received as part of a single response informational feedback. The feedback received from the customer is incorporated with other responses received by the system and a report is generated that is customized to the particular funeral home to report the type of service that is categorized by its own customers. Such information is valuable to the funeral home in rendering service to customers.

Alternatively, the type of report generated is one that compiles information received from customers of various funeral homes to report general service given to customers in the funeral home industry or within a particular geographic area.

In at least some embodiments, control over the system is maintained by a third-party that enables the information gathered to be made available to the service provider, individuals in the service provider's industry, to future customers/receivers of the service, a regulatory group, and/or to the general public.

A system of consumer feedback is provided that a secure internet website calculates into a national rating, which is converted into a marketing advantage by the industry's best professionals which automatically initiates a level of peer leadership with positive peer pressure. This in turn, elevates the care and service for the consumer/receiver of the service because the consumer's comments and ratings generate increased accountability to the consumer. The system, which is not controlled by the service provider, gives the consumer an effective voice to communicate the truth of their experience to other consumers and professionals industry wide. Thus, embodiments of the present invention enhance free enterprise and empower the consumer and professional with the information to improve overall choice in service.

In one embodiment, an internet rating system driven by consumer feedback designed to replicate the control and security of mailing survey questionnaires to professional clientele, by using the internet and state of the art methodologies that enhance security and control of the rating; create an automatic rating system influenced exclusively by the consumer invited to complete a survey, wherein each consumer generated rating contributes to the rating average for the intended professional; drive greater accountability within the profession through a method of standardized feedback and greater consumer awareness; offer a subscription usage of the website to all professionals within any professional service or trade organization for which customer opinions of their service are posted on the internet directly from the consumer for review by the general public, wherein the website is supported financially by the professionals as opposed to advertising revenue; increase value and credibility for the professional when these consumer opinions and ratings are positive, and help them become differentiated from others within the profession whose standards and performance are marginal or lacking but unknown to the consumer; offer first-hand information for the professional to modify and improve service for the consumer/client; facilitate a national and world council of professionals whose service is superior to that of their competition with in each service industry, as determined by the system ratings, wherein once established as a credible rating service, they convert their rating into a marketing advantage by promoting their standing before the general public; provide marketing and media exposure through a media kit provided to every subscriber that assists them in promoting their national rating; foster a new standard as professionals respond to the requests and opinions of the consumer in an attempt to improve their ratings, wherein competition for attracting the consumer based on consumer ratings encourages growth and change toward a higher standard initiated by the consumer, and since the rating system is not manipulated or altered, it promotes change and improvement needed to boost and/or maintain high ratings to compete for clients; offer a clear system of comparing current performance with past performance of each professional using a method of rolling averages that keeps feedback relative to the service offered and a unified system for tracking improvement or decline; and/or empower the consumer with knowledge and information pertaining to service professions that are not available to the public.

The following provide a representative method and stage of delivery. The internet site is specifically engineered for the professional to send an exclusive email letter to the customer following service requesting them to click on a hyperlink included in the email letter, or direct them to the internet rating site address with a code provided by the professional, granting access to a single opportunity to offer their opinions on a scale survey system. The professional limits the internet rating opportunity to his customers and clients. The system allows the professional to independently have these comments and opinions posted for public display and seek an investment by the professional to maintain the site and post ratings and comments to the consumer. Payment by each subscriber is automated by recurring credit card charges through out the unlimited term of the subscription. By way of example, the cost for a single subscription or for each professional rating page can range from $19.00 to $69.00 per month depending on the rating system designed for a particular service profession. Moreover, a one time set up fee (e.g., $500.00 or another amount) may be charged for those desiring assistance in setting up their rating home page in addition to the monthly subscription.

This method provides a measure of control in restricting feedback submitted to their clientele. With all other rated sites, credibility is questionable and anyone, including the competing professional, can submit ratings that could defame and destroy reputations. The risk associated with open forum web sites is too great. Its one thing to criticize a lawn mower for not cutting properly, but to accuse a professional of poor service could cost them their standing in the community and ultimately their career. If they have the measure of control in how and by whom they are rated, they take the risk associated with being rating in public when they see the marketing potential in the venture.

To insure that the rating submissions are not falsified, another failsafe procedure is used with this system known as a “double opt-in” procedure that verifies the location or email address of the survey participant. When they complete a survey, they are automatically sent a confirmation email for which they respond with a blank reply before the survey is accepted as valid. This discourages a professional from “stacking the deck” himself/herself with positive opinions generated from his own office/home computers. The system administrator for the website has access to every email address that submitted a completed survey and can detect fraud or misuse.

If fraud is detected, the professional is suspended for a time, if not indefinitely. Each subscriber agrees to be honest and trustworthy in the “terms of use” when registering to use the system.

The success of the system is dependant upon the credibility of the system. In some embodiments, professionals do not have the ability to submit surveys into the website that they may have received by mail or any other means. They are restricted to being entered directly into the system by the consumer.

In one embodiment, on a scale of 1 to 5, client participants are asked to rate various aspects of service they received by the professional. Each survey is averaged into the system mathematically to display a rating for each category. Since the averages become diluted over time, a series of rolling averages may be used to keep the data fresh and most relevant to the service being provided and to offer a comparison to the ratings received over the last year. Each rating displays an average that reflects the last six months of survey data on the website to the public. Within the reports provided to the subscriber, they are provided with data that reflects their last 3, 6 or 12 month averages. These displays allow the professional to track the improvement or decline of his/her personal performance ratings.

Each individual rating site page for the professional compares their currant rating (6 month average) with the state and national 6 month average for additional relevant perspective.

Additional comments may also be posted by the rating participant along with ratings and comments associated with an individual staff member that served them specifically. This allows for the employees to build a portfolio of service comments that the professional employer can convert into a marketing advantage.

Should a negative comment be posted, the client can be provided with the ability to post an explanation paragraph in rebut. This may appear italicized following the posted comment and offer perspective the consumer may need for interpretation. The client subscriber may also reject comments made by a customer for reasons not limited to violence, vulgarity and defamation. However, in some embodiments the professional is not able to modify or edit the text previously entered by any rating participant. All rejected comments are displayed and may be challenged by members of the advisory council for the grounds on which the client rejected the comment from being posted. If reasons for rejection cannot be substantiated, the advisory council administrators, in accordance with the terms of use, may reverse the client's decision to reject the comment and approve it for posting directly into the system.

The system offers help and support for improving ratings and offers a forum for colleagues to communicate on how to improve service or ask one another questions on posted ratings and comments.

In one embodiment, questions are served up over 4 pages that take minimal time to complete and offer more questions than traditional techniques. More questions asked and answered means that more information is provided to the professional that can be used to improve and refine service.

At the discretion of the subscriber, clients are motivated further to complete a survey by being offered a coupon for savings or a credit on past, current, or future visits or services, or another item of value if they complete the survey.

To facilitate a further marketing advantage for the professional, they have the ability to let their clients hyperlink into the rating site page directly from their own company website page and vise versa.

The following provide representative phases of delivery to the subscriber and/or consumer. When introduced into any given industry or service profession, the first to subscribe are those who see this system as a way to prove to the consumer that the service they offer is a better choice than that of their competition. They utilize the rating system by inviting all their clients and customers to rate them and take the rating they have achieved and promote themselves as “the highest rated professional” in the area according to a national rating service with all the relevant prestige it carries.

In the process of exposing their subscription to the national rating service to the consumer for heightened exposure and marketing advantage, the competition that is not yet subscribing to the rating system becomes aware of the service and feels compelled to subscribe to maintain a market share.

Some of the competition that subscribes to the system may not be rated as high as the first subscribers to join. They may join out of a sense of obligation and to avoid being left behind. They may not be as pleased with their consumer service rating and have two choices: (1) they can improve their service to the consumer though training and greater awareness to the needs and requests of the consumer, or (2) they can cancel the service and no longer participate by allowing their customers to submit their opinions and ratings. The system has their express permission to keep all posted ratings on the site that identify them with the very rating they had when they stopped the service. If it is a poor rating, they can improve the rating by activating it and improving their service. If it was a good rating, it would still be identified to the consumer as inactive because they no longer subscribe to or want to receive ratings, which is not a favorable message to send to the consumer.

At some point, when enough subscribers have joined, the existence and value of the site is marketed directly to the consumer and becomes aware of this rating system, consumers are empowered further to demand service professionals join and be rated if they want to compete for business. Not being a subscriber could raise caution to any prospective client/customer.

In some embodiments, the employees of each professional subscriber have the opportunity to rate their employer, workplace, environment and internal systems and overall moral on a confidential and internal periodic basis as facilitated by an entity, such as the National Consumer Rating Advisory Board (NCRAB). These opportunities for confidential, anonymous and internal employee evaluations of the professional subscriber's establishment would further enhance the health and well being of the business by providing the professional subscriber with valuable information needed for leadership.

Further, this internal rating system may be facilitated and programmed directly into the rating system as an additional feature available to the subscriber at their discretion. This additional feature or service may be available for an additional charge upon negotiation with the subscriber, and remains confidential at all times. No public access to these reports or findings would be possible as are other consumer rating date inherent in the rating systems and would be the ultimate property of the professional or owner/subscriber. System administrators of the internet rating system or NCRAB offer comprehensive reports and analysis on any internal rating data collected to assist the professional or owner in making necessary improvements as appropriate.

A report is then provided to the professional with suggestions on how to improve moral or company structure and benefits, etc.

Everyone that attends a funeral may be invited to rate the funeral service as a whole. The questions asked are customized by each subscriber to provide information for the funeral home to be used for internal quality control purposes only and may not be posted online as would other rating data collected.

To facilitate this Funeral Rating component, the Funeral Home subscriber is given a single code they would use for all funerals. They would post on the program for the deceased or on a special card inserted in the program providing the details of the opportunity to rate the funeral experience following the service at their convenience. The individual that attended the funeral would enter that code together with their email address at the place provided on the home page of the National Funeral Rating web site and answer questions accordingly.

Other advantages of this rating component include the opportunity for the funeral home to assess interest in and share information on preplanning ones own funeral while they may be contemplating the value of the funeral experience. They may have the opportunity to write a letter to the deceased or the family of the deceased to further express their thoughts and feelings. This may be accomplished with a link or connection to a guest registry section for the family and friends of the deceased. Funeral homes subscribers would have the ability to collect these comments relating to a specific service and deliver them to the family following the services as an additional follow-up service that may be associated with aftercare.

Many aspects of the funeral experience could be assessed with this added feature such as the clergy and the comfort and length of the service. These aspects of service quality are different in scope to that of the other rating opportunities afforded the family as previously described as the “receiver of service” or for those financially responsible for the funeral or the person or persons often referred to in the funeral service profession as the informants.

An important feature available to every subscriber within the established program of each internet rating system involves an internal “on” and “off” switch referred to by this rating system program as the On Stage/Off Stage designation. One application of this feature allows the active, paying subscriber to begin using rating services and activities to build a portfolio of rating data within the system in a manner that conceals the data from public access. They have the benefit of privately viewing the rating data collected and posted to their rating home page but do not have the added benefit of having the site accessible by the general public. In this Off Stage designation, the rating data would be accessible by the individual subscriber and the NCRAB system administrators only.

At the discretion of the subscriber, when they desire to give the general pubic access to their established rating home page, they can change their designation to “On Stage.” This change can be done, without additional cost, by the subscriber from within their private member section menu of features. Upon this change in designation, the subscriber's home page would then appear with all current data, together with all other subscribers and their data that are also in an “On Stage” status.

In another application of this feature, the subscriber with an “On Stage” designation can choose to change their designation to “Off Stage” at any time, for any reason at their sole discretion and remain in that designation for as long as they are a current, paying subscriber. This hidden designation avails them the time to improve their ratings, comments or other data as a subscriber and maintain their rating home page and all other services and advantages of membership.

If the subscriber decides to cancel service altogether, the system administrators for NCRAB have the express permission of the subscriber upon registration to post the last and most available data on their home rating page onto the system and identify them as not active.

At some point, when enough subscribers have joined, the existence and value of the site is marketed directly to the consumer though mass marketing strategies to heighten awareness overall. Consumers are empowered further to request their service professionals join and be rated if they want to compete for business. Not being a subscriber with the associated ratings and comments, could ultimately raise caution to any prospective client/customer investigating the service record of the professional.

In some embodiments, information is obtained from a receiver of a service via telephone, such as a telephone survey. In a further embodiment, the information received by the telephone survey is provided into the computer system.

In some embodiments, control over the information received from the receivers of the service is not provided to the professional to ensure the integrity of the information. In some embodiments, an employee of the service provider is allowed to enter information into the system.

In some embodiments, the report is generated by the system, by the particular providers or by the general public. In a further embodiment, a membership is obtained by members of the general public to access the information regarding service providers.

In one embodiment, an individual (e.g., potential customer) can access and/or compile the information of the system based upon any criteria. Such criteria may include, for example, categories of providers, geographical locations, particular types of service, facts pertaining to the service providers, insurance information, information relating to the particular service receivers that reported and/or any other information. The information can be any information that is useful or important to the user.

Thus, for example, in the healthcare or dental industry, a user can identify the professionals who will accept their particular insurance and identify those providers by quality of service. In another example, if a patient desires a female OBGYN doctor, the patient can identify such professionals that satisfy the criteria and identify the providers by quality of service.

Embodiments of the present invention further embrace referral tracking.

In some embodiments of the present invention, results are shared with potential or current customers of the professional. The accessibility and utilization of the information by a user allows a potential or current customer to select a professional based upon the quality of service rating achieved or otherwise assigned, wherein the rating is based on actual service rendered.

Embodiments of the present invention provide integrity of information for the rating service since the information has been obtained from actual receivers of service and maintained by a third party entity.

Thus, as discussed herein, the embodiments of the present invention embrace capturing quality of service. In particular, the present invention relates systems and methods for developing exclusive rights to providing informational feedback relating to a quality of service received from a professional, delivering an authorized request for feedback submission, receiving informational feedback, and selectively compiling the informational feedback received for reporting purposes.

While the methods and processes of the present invention have proven to be particularly useful in the funeral industry, those skilled in the art can appreciate that the methods and processes of the present invention may be used in a variety of different industries to exclusively distribute products to intended recipients based upon exclusive information received from recipients of service. As such, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a system that includes a computer device, a method for obtaining and customizably: reporting exclusive informational feedback information relating to service rendered, the method comprising:
identifying a receiver of a service performed by a professional;
extending an exclusive invitation to the identified receiver to submit informational feedback;
receiving and recording the informational feedback; and
customizably compiling a quality of service report for a potential customer of the professional, wherein the quality of service report includes the informational feedback received.

2. A method as recited in claim 1, wherein the method further comprises providing a unique code for a single submission of the informational feedback.

3. A method as recited in claim 1, wherein said receiving the informational feedback comprises utilization of a telephone system.

4. A method as recited in claim 1, wherein said receiving the informational feedback comprises utilization of an email system.

5. A method as recited in claim 1, wherein said receiving the informational feedback comprises utilization of a website.

6. A method as recited in claim 1, wherein the exclusive invitation is extended by a third party.

7. A method as recited in claim 1, wherein said quality of service report is available for access by the general public.

8. A method as recited in claim 1, further comprising:
identifying a criteria related to at least one of the service, the service provider, and the receiver of the service; and
wherein the quality of service report is further based on the criteria.

9. A method as recited in claim 1, wherein said quality of service report is shared with the competitors of the professional.

10. A method as recited in claim 1, wherein the professional provides a service within one of:
(i) a sales industry;
(ii) a construction industry;
(iii) a personal services industry;
(iv) an automotive industry;
(v) a food industry;
(vi) a healthcare industry;
(vii) a dental industry;
(viii) a legal industry;
(ix) a consulting industry;
(x) a cemetery industry; and
(xi) a cremation industry.

11. A computer program product for implementing within a computer system a method for obtaining and customizably reporting exclusive informational feedback information relating to service rendered, the computer program product comprising:
a computer readable medium for providing computer program code means utilized to implement the method, wherein the computer program code means is comprised of executable code for implementing the steps for:
identifying a receiver of a service performed by a professional;
extending an exclusive invitation to the identified receiver to submit informational feedback;
receiving and recording the informational feedback; and
customizably compiling a quality of service report, wherein the quality of service report includes the informational feedback received.

12. A computer program product as recited in claim 11, wherein the method further comprises providing a unique code for a single submission of the informational feedback.

13. A computer program product as recited in claim 11, wherein said receiving the informational feedback comprises utilization of at least one of:
(i) a telephone system;
(ii) an email system; and
(iii) a website.

14. A computer program product as recited in claim 11, wherein the exclusive invitation is extended by a third party.

15. A computer program product as recited in claim 11, wherein said quality of service report is available for access by the general public.

16. A computer program product as recited in claim 11, further comprising:
identifying a criteria related to at least one of the service, the service provider, and the receiver of the service; and
wherein the quality of service report is further based on the criteria.

17. A computer program product as recited in claim 11, wherein said quality of service report is shared with the competitors of the professional.

18. A computer program product as recited in claim 11, wherein the professional provides a service within one of:
(i) a sales industry;
(ii) a construction industry;
(iii) a personal services industry;
(iv) an automotive industry;
(v) a food industry;
(vi) a healthcare industry;
(vii) a dental industry;
(viii) a legal industry;
(ix) a consulting industry;
(x) a cemetery industry; and
(xi) a cremation industry.

19. A method for exclusively capturing quality of service, the method comprising:
extending exclusive invitations to receivers of services to submit informational feedback, wherein the services were provided by one or more professionals;
collecting the informational feedback; and
customizably compiling a quality of service report that assists individuals to determine from which of the professionals to obtain the services.

20. A method as recited in claim 19, wherein the quality of service report is further based on criteria of interest to one or more of the individuals.
